(19) United States
(12) Patent Application Publication
(10) Pub. No.: US 2024/0007045 A1
(43) Pub. Date: Jan. 4, 2024

(54) WINDOW-TYPE SUNLIGHT TRACKING SYSTEM

(71) Applicant: LEEYOUNG S&D CO., LTD., Ansan-si, Gyeonggi-do (KR)

(72) Inventors: Young Sub LEE, Gwangmyeong-si (KR); Jin Young YOUN, Gwangmyeong-si (KR)

(21) Appl. No.: 18/253,806

(22) PCT Filed: Nov. 1, 2021
(86) PCT No.: PCT/KR2021/015534

§ 371 Date: May 22, 2023

(30) Foreign Application Priority Data
Nov. 26, 2020 (KR) 10-2020-0160942

(51) Int. Cl. H02S 20/32

(52) U.S. Cl. CPC H02S 20/32

(57) ABSTRACT

Provided is a window/door-type photovoltaic tracking system minimizing an incident angle of sunlight for a PV panel from sunrise to sunset using a simple one-axis control method of lifting and lowering a lower part of a solar panel, and sunlight is tracked using one-axis control by implementing a window/door-type photovoltaic tracking system including a time information provider, an input unit, an inclination controller, and a panel driver.

### TECHNICAL FIELD

The present invention relates to a window/door-type photovoltaic tracking system, and more particularly to a window/door-type photovoltaic tracking system optimizing an incident angle of the sun for a PV panel from sunrise to sunset using a simple one-axis control method of lifting and lowering a lower part of a solar panel.

### BACKGROUND ART

In general, a generation method using solar power has advantages of using infinite clean energy, not requiring a separate energy or driving source, being simply constructed regardless of whether a system is small or large, and not being affected by installation restrictions due to environmental problems, and thus possibilities thereof are endless.

A solar panel (PV panel) is mainly installed and operated on a roof of a large building or on land. However, in recent years, installation of solar panels on roofs, windows, doors, etc. of general homes has been increasing.

A solar panel installed on a roof, a window, or a door of a general home has a smaller degree of freedom in installation direction (azimuth and location) when compared to a solar panel in an independent facility installed on a roof of a large building or on land, and thus active development is different due to diurnal changes of the sun.

In general, a solar power tracker is a two-axis control method that tracks the azimuth and altitude of the sun.

It is not easy to install a two-axis control system on the roof, the window, or the door of a general home for space or economic reasons.

A solar tracking power generation system installed on a window or a door of a general home is disclosed in <Patent Document 1>below.

In a conventional art disclosed in <Patent Document 1>, a moving frame, in which a solar cell module is installed, is installed on a chassis of an apartment veranda, an altitude h is controlled through vertical movement of the moving frame, and an azimuth Zₙ is controlled through horizontal movement of the solar cell module.

Such a conventional art is a photovoltaic tracking system of a two-axis control method, namely, altitude control and azimuth control, and thus has disadvantages in that system implementation is complicated, there are many required parts, and power consumption is high since power is required for 2-axis control.
(Patent Document 1) Korean Registered Patent No. 10-1828514 (registered on Feb. 6, 2018) (Household Type Tracking Photovoltaic Power Generation Apparatus)

### DISCLOSURE

### Technical Problem

Therefore, the present invention has been proposed in view of various problems occurring in general homes, window/door-type solar power generation systems, and conventional technologies described above, and it is an object of the present invention to provide a window/door-type photovoltaic tracking system optimizing an incident angle of the sun for a PV panel from sunrise to sunset using a simple one-axis control method of lifting and lowering a lower part of a solar panel.

It is another object of the present invention to provide a window/door-type photovoltaic tracking system for calculating an optimized inclination considering an azimuth of a PV panel to track sunlight using a method of vertically tilting the PV panel using a one-axis control method, thereby simplifying implementation of the window/door-type photovoltaic tracking system and minimizing power consumption.

### Technical Solution

In accordance with the present invention, the above and other objects can be accomplished by the provision of a “window/door-type photovoltaic tracking system” including

a time information provider configured to provide current time information,

an input unit configured to input azimuth and location information of a solar panel, which is information on a direction in which the solar panel is oriented,

an inclination controller configured to calculate a location of the sun at a current time using the current time information, calculate an azimuth and an altitude of the sun using location information of the solar panel provided by the input unit based on calculated location information of the sun, and calculate and output an inclination adjustment value of the solar panel using azimuth information of the solar panel provided by the input unit based on calculated azimuth and altitude information of the sun, and

a panel driver configured to adjust an inclination of the solar panel according to the inclination adjustment value output from the inclination controller.

The inclination controller may calculate the inclination adjustment value of the solar panel so that an incident angle of sunlight is minimized.

The inclination controller may include a location calculator configured to calculate a location of the sun at a corresponding time,

an azimuth and altitude calculator configured to calculate an azimuth and an altitude of the sun using location information of the solar panel based on location information of the sun calculated by the location calculator, and

an inclination adjustment value calculator configured to calculate and output an inclination adjustment value of the solar panel at which the incident angle of sunlight is minimized using azimuth information of the solar panel provided by the input unit based on azimuth and altitude values of the sun calculated by the azimuth and altitude calculator.

### Advantageous Effects

According to the present invention, implementation may be performed so that an incident angle of the sun is optimal for a PV panel from sunrise to sunset using a simple one-axis control method of lifting and lowering a lower part of a solar panel, and thus there is an effect of promoting optimal solar power generation by one-axis control.

Another object of the present invention may calculate an optimized inclination considering an azimuth of a PV panel to optimally track sunlight using a method of vertically tilting the PV panel using a one-axis control method, and thus has effects of simplifying implementation of a window/door-type photovoltaic tracking system and minimizing power consumption.

### DESCRIPTION OF DRAWINGS

FIG. 1 is an operational example of a window/door-type photovoltaic tracking system according to the present invention;

FIG. 2 is a block diagram of the window/door-type photovoltaic tracking system according to the present invention;

FIG. 3 is a control conceptual diagram (side view) of a solar panel applied to the window/door-type photovoltaic tracking system in the present invention; and

FIG. 4 is a conceptual diagram for calculating inclination adjustment information PV_h of the solar panel in the present invention.

### BEST MODE

Hereinafter, a window/door-type photovoltaic tracking system according to a preferred embodiment of the present invention will be described in detail with reference to the accompanying drawings.

The terms or words used in the present invention described below should not be construed as being limited to conventional or dictionary meanings, and should be interpreted as having meanings and concepts consistent with the technical idea of the present invention based on a principle that the inventor may properly define the concept of terms in order to describe the invention in the best way.

Therefore, embodiments described in this specification and configurations shown in the drawings are only preferred embodiments of the present invention, and do not represent all of the technical spirit of the present invention, and thus it should be understood that there may be various equivalents and variations that may substitute therefor at the time of this application.

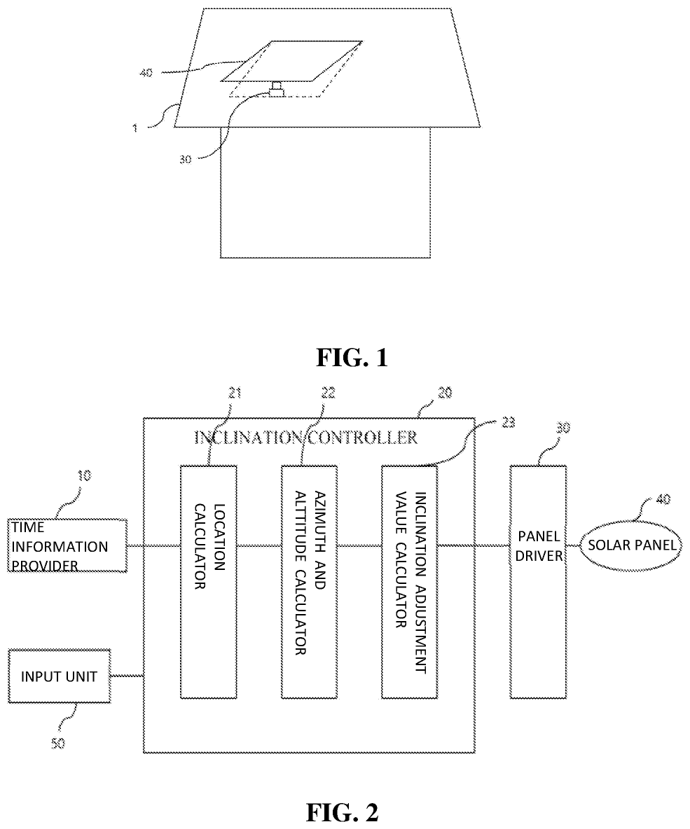

FIG. 1 is an operational example of a window/door-type photovoltaic tracking system according to a preferred embodiment of the present invention, and is the case where a solar panel (PV panel) 40 is installed on a roof 1 of a general home.

A panel driver 30 configured to adjust an inclination of the solar panel 40 using a one-axis control method, which is a simple tilting method of lifting or lowering the solar panel 40, is coupled to and installed at a lower part of the solar panel 40. Here, the panel driver 30 may implement a tilting operation of lifting or lowering the solar panel 40 using only one actuator or one motor.

FIG. 2 is a configuration diagram of the “window/door-type photovoltaic tracking system” according to the present invention, and may include a time information provider 10 configured to provide current time information, an input unit 50 configured to input azimuth and location information of the solar panel 40, which is information on a direction in which the solar panel 40 is installed, an inclination controller 20 configured to calculate a location of the sun at a current time using the current time information, calculate an azimuth and an altitude of the sun using the location information of the solar panel provided by the input unit based on calculated location information of the sun, combine calculated azimuth and altitude information of the sun and azimuth information of the solar panel provided by the input unit to calculate an inclination adjustment value of the solar panel, and output the inclination adjustment value, and a panel driver 30 configured to adjust an inclination of the solar panel 40 according to the inclination adjustment value output from the inclination controller 20.

The inclination controller 20 may calculate the inclination adjustment value of the solar panel 40 so that an incident angle of sunlight is minimized.

The inclination controller 20 includes a location calculator 21 configured to calculate a location of the sun at a corresponding time provided by the time information provider 10, an azimuth and altitude calculator 22 configured to calculate an azimuth and an altitude of the sun using location information of the solar panel based on location information of the sun calculated by the location calculator 21, and an inclination adjustment value calculator 23 configured to combine the azimuth and the altitude of the sun calculated by the azimuth and altitude calculator 22 and an azimuth value of the solar panel provided by the input unit 50 to calculate an inclination adjustment value of the solar panel 40 at which an incident angle of the sun is minimized, and output the inclination adjustment value.

An operation of the window/door-type photovoltaic tracking system according to the present invention configured as described above will be described below in detail with reference to FIGS. 1 to 4, which are the accompanying drawings.

The present invention uses the one-axis control method allowing simple tilting of lifting or lowering the lower part of the solar panel so that an incident angle of sunlight is optimal, thereby optimally tracking the sun.

In particular, a tilting angle of the solar panel is calculated in an environment in which an incident angle of the sun on the PV panel may be optimal from sunrise to sunset by operating one axis according to arbitrary time intervals.

Mathematically, a solar one-axis tracking method according to changes in the location of the sun is proposed in which a distance of the spherical meridian of the azimuth is shortest, that is, the incident angle i is calculated to be minimal, based on a direction (azimuth) in which the solar panel is installed.

To this end, current time information is provided through the time information provider 10. Here, the time information means the international standard time (GMT, Greenwich mean time).

In addition, the input unit 50 inputs azimuth (PV_Zₙ) and location (longitude (Long) and latitude (Lat)) information of the solar panel 40, which is information on the direction in which the solar panel 40 is installed.

Here, a position of the sun is one of coordinates used to indicate the location of the sun, and is information on coordinates (GHA, Dec) of the sun on the celestial sphere.

The location calculator 21 of the inclination controller 20 detects the location of the sun at a current time provided by the time information provider 10.

That is, the location (GHA, Dec) of the sun at the current time is calculated using the current time information (GMT) at the location where the solar panel 40 is installed. Here, the location of the sun at the current time is preferably calculated at regular time intervals.

Next, the azimuth and altitude calculator 22 calculates the azimuth Zₙ and the altitude h of the sun at the current location using the location information of the sun calculated by the location calculator 21.

Here, the following [Equation 1] may be used to calculate the altitude and the azimuth of the sun.

h= [symbol] (sin(Dec)×sin(Lat)+cos(Dec)×cos( [symbol] )×cos( [symbol] ))*Zₙ= [symbol] ((sin(Dec)−sin(Lat)*sin(h))/(cos(Lat)×cos(h)), if(sin( [symbol] )>0,then Zₙ=360−Zₙ [Equation 1]

Here, h denotes an altitude angle of the sun, Zₙ denotes an azimuth angle of the sun, GHA denotes Greenwich Hour Angle, Dec denotes declination, Lat denotes latitude, and Long denotes longitude. At this time, the longitude has a (+) value in the case of the east and a (−) value in the case of the west.

Next, when the azimuth and the altitude obtained at the location (GHA, Dec) of the sun are denoted by (Zₙ, h), and a direction (azimuth) of an installed one-axis PV panel is denoted by PV_Zₙ, the inclination adjustment value calculator 23 may obtain inclination adjustment information PV_h of the panel (see FIG. 3) as follows.

On the Euclidean plane, a method of finding a closest distance from a point to any line segment is to draw a perpendicular line from the point onto the line segment. In the same way, a distance closest to any meridian from a point on a sphere is the great circle perpendicular to the meridian.

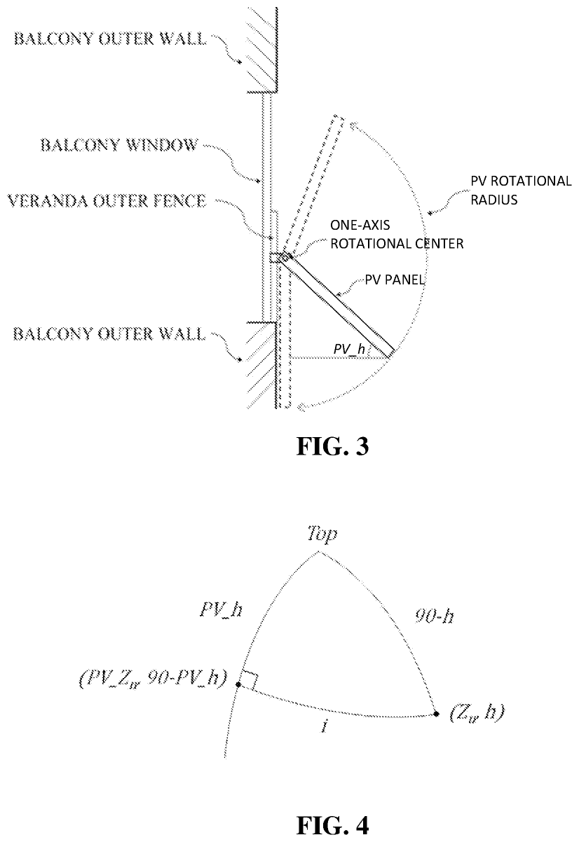

Referring to FIG. 4, Zₙ and PV_Zₙ are azimuth components and have characteristics of longitude when expressed on a sphere. h and PV_h are altitude and inclination components, and have characteristics of latitude when expressed on a sphere.

In the case of control of a two-axis solar panel, the azimuth Zₙ and the altitude h of the sun are calculated from the location of the PV panel, and an azimuth PV_Zₙ and tilt information 90-PV_h of the PV panel are adjusted to match Zₙ and h, respectively.

However, in the case of one-axis control that only controls vertical tilting, since PV_Zₙ is fixed to one arbitrary azimuth, the changing Zₙ and the fixed PV_Zₙ cannot be matched in most cases.

The only controllable variable is PV_h, and merely matching (90-PV_h) equal to h does not minimize the incident angle i of sunlight.

That is, since PV_Zₙ is fixed and cannot be moved, PV_h needs to be calculated so that the incident angle i of sunlight incident on the solar panel is minimized by controlling only the adjustable PV_h. The meridian including PV_Zₙ is fixed (due to fixation of the azimuth) and Zₙ moves every moment (diurnal motion due to movement of the sun). At this time, to connect a closest distance from a point (Zₙ, h) to the meridian including PV_Zₙ, a great circle perpendicular to this meridian is required, and an incident angle of sunlight, a distance of which from Zₙ on the great sphere to the meridian including PV_Zₙ is the closest, is obtained.

Therefore, it is an object of the present invention to calculate PV_h at which the incident angle i of sunlight is minimized at every moment (arbitrary time intervals). An expression thereof as a formula is as shown in the following [Equation 2].

[symbol]

= [symbol] (sin(h)/(cos( [symbol] (cos(h)*sin(Zₙ− [symbol] ))))), [symbol] (cos(Zₙ− [symbol] )<0,then [symbol] =− [symbol] [Equation 2]

Here, PV_h denotes an inclination angle of the solar panel, and PV_Zₙ denotes an azimuth angle of the solar panel, respectively. At this time, PV_h indicates a degree of inclination of the solar panel and is shown in FIG. 3.

The above [Equation 2] has the following meaning.

At the location where the solar panel 40 is installed, an installation azimuth of the solar panel is PV_Zₙ, and it is an object of the present invention to adjust the system by obtaining an optimal degree of inclination of the solar panel, that is, PV_h, with respect to movement of the sun.

To this end, the location (GHA, Dec) of the sun at the current time is calculated, and in this way, the azimuth Zₙ and the altitude h of the sun are calculated at the current location (where the solar panel is installed).

Thus, PV_h is calculated using (Zₙ, h) and PV_Zₙ.

In other words, even though the altitude h of the sun has been calculated, PV_h is calculated again without using this h since h is an altitude value for two-axis control, and thus when h is used for one-axis control, the effect of the azimuth cannot be improved. Therefore, optimized inclination information PV_h of the PV panel is calculated according to combined calculation of the azimuth Zₙ of the sun, the altitude h of the sun, and the azimuth PV_Zₙ of the PV panel, and is used for one-axis control therefor.

Here, the inclination adjustment value calculator 23 adjusts inclination of the solar panel 40 through the panel driver 30 using the calculated final PV_h. The inclination information of the solar panel 40 for the final PV_h calculated here may be previously stored in an internal memory in the form of a look-up table and used. Then, the calculated inclination information is compared with the inclination information of the current solar panel 40, and only a difference therebetween is output to the panel driver 30 as a panel inclination control value. Here, the panel inclination control value becomes a control value for lifting or lowering the solar panel 40.

The panel driver 30 adjusts the solar panel 40 using the one-axis control method of lifting or lowering the solar panel 40 as shown in FIG. 1 in response to the delivered panel inclination control value. That is, efficiency of solar power generation is increased by adjusting the PV panel to tilt in one axis at the corresponding time.

Since the panel driver 30 adjusts the inclination of the solar panel 40 using the one-axis control method, it is possible to adjust the inclination of the solar panel 40 by using only one actuator or one motor, so that solar equipment may be manufactured as a tracking system having improved efficiency. As a result, it is possible to implement a solar tracking power generation system that is simple, is inexpensive, and consumes less power.

In this way, the present invention does not simply track only the altitude of the sun and performs one-axis control by calculating an optimized inclination considering direction information of the currently installed solar panel, that is, the installation azimuth of the solar panel. In particular, by using the one-axis control method, it is possible to provide a photovoltaic tracking system that consumes less power and has a simple system. The invention made by the present inventors has been specifically described

according to the above embodiments. However, the present invention is not limited to the above embodiments, and it is obvious to those skilled in the art that various changes may be made without departing from the gist thereof.

### REFERENCE SIGNS LIST

10: TIME INFORMATION PROVIDER
20: INCLINATION CONTROLLER
21: LOCATION CALCULATOR
22: AZIMUTH AND ALTITUDE CALCULATOR
23: INCLINATION ADJUSTMENT VALUE CALCULATOR
30: PANEL DRIVER
40: SOLAR PANEL
50: INPUT UNIT

1. A window/door-type photovoltaic tracking system comprising:
a time information provider configured to provide current corresponding time information;
an input unit configured to input azimuth and location information of a solar panel, which is information on a direction in which the solar panel is oriented;
an inclination controller configured to calculate a location of the sun at a current time using time information provided by the time information provider, calculate an azimuth and an altitude of the sun at a location where the solar panel is installed provided by the input unit based on calculated location information of the sun, combine the calculated azimuth and altitude of the sun and an azimuth of the solar panel provided by the input unit to calculate an inclination adjustment value of the solar panel, and output the inclination adjustment value; and
a panel driver configured to adjust an inclination of the solar panel according to the inclination adjustment value output from the inclination controller.

2. The window/door-type photovoltaic tracking system according to claim 1, wherein the inclination controller calculates the inclination adjustment value of the solar panel so that an incident angle of sunlight is minimized.

3. The window/door-type photovoltaic tracking system according to claim 1, wherein the inclination controller comprises:
a location calculator configured to calculate a location of the sun at a current time at the location where the solar panel is installed;
an azimuth and altitude calculator configured to calculate an azimuth and an altitude of the sun using the location of the solar panel based on location information of the sun calculated by the location calculator; and
an inclination adjustment value calculator configured to combine the azimuth and the altitude of the sun calculated by the azimuth and altitude calculator and an azimuth value of the solar panel to calculate and output an inclination adjustment value of the solar panel at which an incident angle of sunlight is minimized.

4. The window/door-type photovoltaic tracking system according to claim 3, wherein the azimuth and altitude calculator for the sun calculates an altitude and an azimuth of the sun using the following equation:
h= [symbol] (sin(Dec)*sin(Lat)+cos(Dec)*cos( [symbol] )*cos( [symbol] ), [symbol] = [symbol] ((sin(Dec)−sin(Lat)*sin(h))/(cos(Lat)*cos(h))), [symbol] (sin( [symbol] )>0),then [symbol] =360− [symbol]
where h denotes an altitude angle of the sun, Zₙ denotes an azimuth angle of the sun, GHA denotes Greenwich Hour Angle, Dec denotes declination, Lat denotes latitude, and Long denotes longitude, the longitude having a (+) value in a case of east and a (−) value in a case of west at this time.

5. The window/door-type photovoltaic tracking system according to claim 3, wherein the inclination adjustment value calculator calculates inclination adjustment information of the solar panel minimizing the incident angle of sunlight using the following equation: [symbol]
= [symbol] (sin(h)/(cos( [symbol] (cos(h)*sin(Zₙ− [symbol] ))))), [symbol] (cos(Zₙ− [symbol] )<0,then [symbol] =− [symbol]
where PV_h denotes an inclination angle of the solar panel, and PV_Zₙ denotes an azimuth angle of the solar panel, respectively.
